(19) United States
(12) Patent Application Publication
(10) Pub. No.: US 2015/0293902 A1
(43) Pub. Date: Oct. 15, 2015

(54) METHOD FOR AUTOMATED TEXT PROCESSING AND COMPUTER DEVICE FOR IMPLEMENTING SAID METHOD

(71) Applicant: Aleksandr Yurevich BREDIKHIN, Moscovskaya obl., g. Klin (RU)

(72) Inventors: Aleksandr Yurevich Bredikhin, Moscovskaya obl. (RU); Nikolai Evgenevich Sergeichev, Ulyanovskaya obl. (RU)

(21) Appl. No.: 14/408,267

(22) PCT Filed: Apr. 26, 2012
(86) PCT No.: PCT/RU2012/000328

§ 371 Date: May 25, 2015

(30) Foreign Application Priority Data
Jun. 15, 2012 (RU) 2011124155

(51) Int. Cl. G06F 17/27; G06F 17/28

(52) U.S. Cl. CPC G06F 17/2785; G06F 17/28; G06F 17/2705; G06F 17/2775

(57) ABSTRACT

The method includes combining words into syntagmas, putting stresses at the ends of the syntagmas and, subsequently, transcribing the syntagmas for the purpose of obtaining syntagma transcriptions in terms of phonemes and allophones. In addition, a database of reference allophones is formed. Coincidences between the syntagma transcription allophones are compared to reference allophones, and syntagma transcription allophones that do not coincide with reference allophones are excluded. Balanced text syntagmas, i.e., those having a greatest number of coincidences between the syntagma transcription allophones and reference allophones, are formed from syntagma transcription allophones coinciding with reference allophones. The device includes a text input unit, an analysis unit, a database unit, and a result submission unit. A parameter input unit and a balanced syntagma forming unit are added.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The invention relates to information technologies and, in particular, to preliminary processing of text information, and may be used in speech recognition and synthesis, database annotation, automatic synchronous interpretation from one language to another, text-based correction of phonograms, source text-based voice conversion, and other technical fields where text information is to be processed by computer means.

2. Description of Related Art Including Information Disclosed Under 37 CFR 1.97 and 37 CFR 1.98.

It is known that efficiency of modern speech-recognition systems depends to a large extent on an accuracy degree of representing language phonetic phenomena with the use of mathematical structures. For this purpose, large databases are used that contain hundreds of hours of speech records made by a plurality of speakers, as well as phonetic transcriptions of these records that are made automatically according to canons. However, rules may be violated in real speech, and, consequently, mathematical structures obtained in the result of processing such databases will not describe a speech signal with high accuracy.

Modern allophonic bases used in text-based speech synthesis require big memory volumes and high efficiency and speed of information processing. These bases may contain a mini-set of allophones and a maxi-set of allophones (National Academy of Sciences of Belorussia, Joint Institute for Informatics Problems. B. M. Lobanov, L. I. Tsirulnik. “Speech Computer Synthesis and Cloning”, Minsk, Belorusskaya Nauka, 2008, p. 198-243). A maxi-set of allophones is more detailed and requires a big text volume for teaching of synthesis systems. A mini-set of allophones is less detailed, but it enables with a great possibility, when used according to certain methods, to obtain a whole totality of allophones when a speaker reads a lesser number of phrases from a text.

A method for compilation phonemic synthesis of Russian speech and a device for implementing same is known (RU, 2298234). The device comprises a text processor that performs the following functions: text normalization; phonetic transcription for separating a word into phonetic units according to the priority principle; identification of sound units; selection of phoneme combinations of the kind “consonant-vowel-consonant-consonant” (CVCC) and consonant-vowel-consonant (CVCfinal); organization of control of compilation element parameters and syllable stresses.

The known method may be implemented as follows. Information after the text processor, being relieved from numerals and punctuation symbols, is a sequence of sound unit identifiers which comes, together with an stress attribute, to the input of an acoustic database. At the same time, the text processor produces, in the result of selection of phoneme sequence of the CVCC and CVCfinal kinds, an attribute for forming a CVC compilation fragment that comes to the CVC forming unit.

Disadvantages of text processing according to the known method includes bad transcribing of word parts, since higher-level relations are not taken into account. Consequently, word stresses may be put incorrectly, and phrase stresses are not just put. Information on pauses is absent, and accuracy of processing texts without it is lowered. Applicability of the invention is limited, since it is aimed just on synthesis with the use of a pre-set base of phoneme units.

The closest to this invention is a method for preliminary text processing by a text processor, comprising reduction of a source text to a normalized orphographic text by converting abbreviations into a linear text, segmentation of the text into sentences and words, marking of phrase and word stresses, combination of words into syntagmas with putting pause symbols at the syntagma ends and, then, transcription of the syntagmas for obtaining ideal transcriptions of the syntagmas in terms of phonemes and allophones (RU, 2386178).

According to this method, the transcription modeling rules are applied to syntagma ideal transcriptions, then, after applying the transcription modeling rules, additional transcription variants are obtained to which the transcription modeling rules are also applied, identical transcriptions are excluded from a total list of the source and obtained additional transcription variants, and transcriptions remained in the list are stored for further use.

The invention enables to form a maximum possible number of articulation variants for the purpose of subsequently selecting closest to those pronounced by a speaker. Transcription modeling is based on the use of the modeling rules which list is formed both on the basis of knowledge of admissible departures of a real articulation from the articulatory norm, and in the result of collection and processing of statistical information. This dual approach to formulating the rules enables to construct transcriptions closest to articulations occurring in the real life.

The limitation of this method, if it is used in speech recognition and synthesis, is that in the mode of teaching such systems phrases are selected by a speaker directly, but he/she is not able to use the most phonetically corresponding text and phrases for presenting them by his/her own voice. This lowers re-voicing quality. Furthermore, the method requires highly productive equipment (high speed of information processing) for its implementation, since it requires multiple use of rather complex rules of transcription modeling, and, as a result, a plurality of additional transcription variants are obtained, from which it is difficult to select needed ones, and which may not be most typical (balanced) phonetically for a pronounced text.

A computer device for text processing is known, comprising a text input unit, an analysis unit, a database unit, a result submission unit, wherein the first output of the text input unit is connected to the first input of the analysis unit, and the output of the database unit is connected to the second input of the analysis unit (RU, 2113726).

This device is designed for use by blind people and as a means for teaching the Russian language. It enables to ensure high quality of Russian speech synthesis when re-voicing flat-bed texts.

The device has the text input unit that is made optical and intended for recognizing flat-bed texts, the analysis unit included in the unit of synthesizing Russian speech according to an orphographic text, the database unit, and the result submission unit made in the form of a tactile display. Furthermore, the device comprises an audio-signal formation unit, a text file unification unit, a unit for interfacing the tactile display with a personal computer, and an interface unit.

A speaker's voice is to be used in this device in the teaching process, as in the known method, and the device has all the drawbacks described above for the method.

### SUMMARY OF THE INVENTION

This invention is based on the objective of developing a method for automated text processing and a device for implementing same that would enable to improve processing quality, raise a speed of data to be processed, reduce a number of information resources, simplify execution, and, thus, improve performance.

In order to achieve the above objective, the known method for preliminary text processing by a text processor, comprising reduction of a source text to a normalized orphographic text by converting abbreviations into a linear text, segmentation of the text into sentences and words, marking of phrase and word stresses, combination of words into syntagmas with putting pause symbols at the syntagma ends and, then, transcription of the syntagmas for obtaining syntagma transcriptions in terms of phonemes and allophones, is modified according to the invention in such a way that, in obtaining syntagma transcriptions in terms of phonemes and allophones a database of reference allophones is formed in the text processor, comparison of coincidences between syntagma transcription allophones and reference allophones is carried out, then syntagma transcription allophones that do not coincide with reference allophones are excluded, and then syntagma transcription allophones coinciding with reference allophones are used for forming balanced text syntagmas having a greatest numbers of coincidences between syntagma transcription allophones and reference allophones.

Further embodiments of the method are possible, wherein it is expedient that:
balanced syntagmas are formed as a table in the order of their balance;
a number of balanced syntagmas is limited;
a minimum percent of balanced syntagmas in a total number of syntagmas is pre-set;
a process of reducing the reference allophone database is carried out, wherein reference allophones contained in the most balanced text syntagma are excluded from that most balanced text syntagma, then reference allophones contained in the next, less balanced text syntagma are excluded therefrom, and this process of reducing the reference allophone database is repeated for the next, less balanced syntagmas for achieving a pre-set number of balanced syntagmas or a pre-set percent of balanced syntagmas in the total number of syntagmas.

In order to achieve the above objective the known computer device for text processing that comprises a text input unit, an analysis unit, a database unit, a result submission unit, wherein the first output of the text input unit is connected to the first input of the analysis unit, and the output of the database unit is connected to the second input of the analysis unit according to the invention is additionally provided with a parameter input unit, a balanced syntagma forming unit, wherein the output of the parameter input unit is connected to the database unit input intended for forming a reference allophone database, the output of the analysis unit is connected to the second input of the database unit, the output of the database unit is connected to the input of the balanced syntagma forming unit, said balanced syntagmas being those having a greatest number of coincidences between text allophones and reference allophones, and the output of the balanced syntagma forming unit is connected to the input of the result submission unit.

The above-described advantages as well as specific features of this invention are explained below on its most preferred embodiment with reference to the accompanying drawings.

### BRIEF DESCRIPTION OF THE DRAWINGS

FIG. 1 shows a schematic view of the functional diagram of the inventive device.

FIG. 2 shows a schematic view of the block diagram of the device operation algorithm.

FIG. 3 shows a schematic view of the block diagram of the algorithm used in the balanced syntagma forming unit.

FIG. 4 shows a screen capture view of the graphic interface for inputting a text file.

FIG. 5 shows a screen capture view of the graphic interface for indicating a text language and the path to its file.

FIG. 6 shows a screen capture view of the graphic interface for editing a stress dictionary.

FIG. 7 shows a screen capture view of the graphic interface for editing an allophone list.

FIG. 8 shows a screen capture view of the graphic interface for retrieving balanced syntagmas.

FIG. 9 shows a screen capture view of the graphic interface for inputting text analysis parameters.

FIG. 10 shows a screen capture view of the graphic interface of formed balanced syntagmas.

### DETAILED DESCRIPTION OF THE DRAWINGS

A metal-polymeric For the purpose of explaining the invention more clearly, definitions for the terms used in the specification will be given below.

Syntagma (from Greek “syntagma”, literally means “arranged together, combined”) is a phonetic whole conveying a single semantic whole in the process of speech or thought; a minimum unit after separating an utterance by intonation means; may be treated as a sequence of allophones from one pause to another. Syntagmas are limited by punctuation marks.

Phoneme (from Greek “phonema” sound) is a minimum sound unit of a language, which is not separated linearly, serves for formation of sound envelopes of meaning units and conditionally coupled with the sense of the language sound system; an ultimate element obtained by linear separation of speech. Phonemes are substituted for symbols in accordance with a phoneme reference book.

Allophone (from Greek “allos”—other, and phone—sound) is a variant or kind of a phoneme, which is conditioned by a given phonetic environment. Allophones are substituted for phonemes according to certain rules.

Transcription (means “writing over again”, from Latin “trans-”−over+scribo “draw, write”) is a special kind of speech writing that is used for fixing speech sounding peculiarities. Transcription describes a real or potential sound realization of a text in terms of phonemes and allophones. There are two main kinds of transcription—phonematic and phonetic; the first reflects the phoneme composition of a word or a sequence of words, the second reflects peculiarities of phoneme realizations in different conditions.

Transcription symbol means a sign or a sequence of signs denoting a phoneme, an allophone or a pause in syntagma transcription.

Transcribing means conversion of a speech text record (for example, a sequence of words forming a syntagma) into a sequence of transcription symbols (transcription).

Ideal transcription (canonical) is a phonetic transcription corresponding to the language pronouncing norm.

Since the claimed method may be realized directly when the inventive computer device is operated, this description characterizes it first in statics, and the method is disclosed in the description of the device operation.

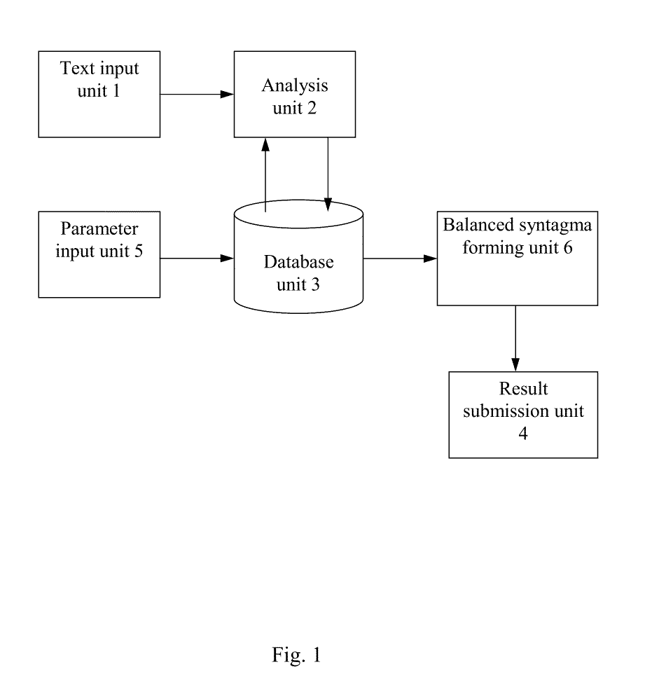

The computer device for text processing (FIG. 1) comprises the text input unit 1, the analysis unit 2, the database unit 3, the result submission unit 4. The output of the text input unit 1 is connected to the first input of the analysis unit 2. The output of the database unit 3 is connected to the second input of the analysis unit 2. The computer device is additionally provided with the parameter input unit 5 and the balanced syntagma forming unit 6. The output of the parameter input unit 5 is connected to the input of the database unit 3. The output of the analysis unit 2 is connected to the second input of the database unit 3. The output of the database unit 3 is connected to the input of the balanced syntagma forming unit 6. The output of the balanced syntagma forming unit 6 is connected to the input of the result submission unit 4.

The text input unit 1 serves for loading a text to be analyzed from a text file with the use of inputting devices (keyboard, scanning device, etc.).

The analysis unit 2 is intended for (a) forming syntagmas on the basis of a text analyzed; (b) substituting (displaying) phonemes for syntagmas symbols (letters); (c) substituting (displaying) allophones for phonemes; (d) search for allophones coinciding with reference allophones in a text; (e) determining a number of coinciding allophones in an analyzed text (i.e., determining a set of records of the kind: “text allophone coinciding with a reference one”—“their number in this text”).

The database unit 3 serves for storing the following information: text analysis parameters; a stress reference book; a reference allophone list; a list of coinciding allophones—their number in a text; results of a text analysis for coinciding allophones.

The result submission unit 4 is intended for submitting results of an automated phonetic analysis of a text to the user. The result of a text analysis is a set of most phonetically balanced syntagmas extracted therefrom. Text analysis results may be displayed to the user through various information output devices (monitor, printer, etc.).

The parameter input unit 5 serves for inputting text analysis parameters by the user with an input device (keyboard, mouse, etc.). The text analysis parameters are: a number of balanced syntagmas outputted in search results, a minimum total percent of syntagma balance, an algorithm to be used for a text analysis (corresponding software).

Balanced syntagma forming unit 6 is intended for creating balanced syntagmas according to coinciding allophones—[phrases (sentences)] having a greatest number of coincidences between text allophones and reference allophones from the unit 3.

The device (FIG. 1) works as follows.

A text to be analyzed comes from the unit 1 to the first input of the analysis unit 2. Text analysis parameters, a list of reference allophones, and a stress reference book come from the parameter input unit 5 to the database unit 3 where they are stored and then come to the second input of the analysis unit 2. The unit 2 reduces the source text to a normalized orphographic text by converting abbreviations into a linear text. Then, the unit 2 separates the text into sentences and words, marks phrase and word stresses, combines the words into syntagmas and puts pause symbols at the ends of the syntagmas. After syntagmas are formed by the unit 2, they are transcribed for the purpose of producing syntagma transcriptions in terms of phonemes and allophones. The unit 2 compares whether the source text allophones coincide with reference allophones, and excludes the text allophones that do not coincide with reference allophones. Then, the unit 2 makes a list: coinciding allophones—their number, that comes to the unit 3. This list comes from the unit 3 to the balanced syntagma forming unit 6 that makes, in essence, reverse conversion of the text relative to the transcription operation performed by the unit 3, namely, phonemes are formed from allophones, then balanced syntagmas are determined that have the greatest number of coincidences between the source text allophones and reference allophones. A list of phonetically balanced syntagmas is formed at the output of the unit 6 from coinciding allophones depending on a number of allophone coincidences. The reference allophones of the unit 3 in this invention are understood allophone databases formed in accordance with a method for producing a mini-set of allophones or a maxi-set of allophones, e.g., the method described in the above-mentioned information source: B. M. Lobanov, L. I. Tsirulnik, “Speech Computer Synthesis and Cloning”.

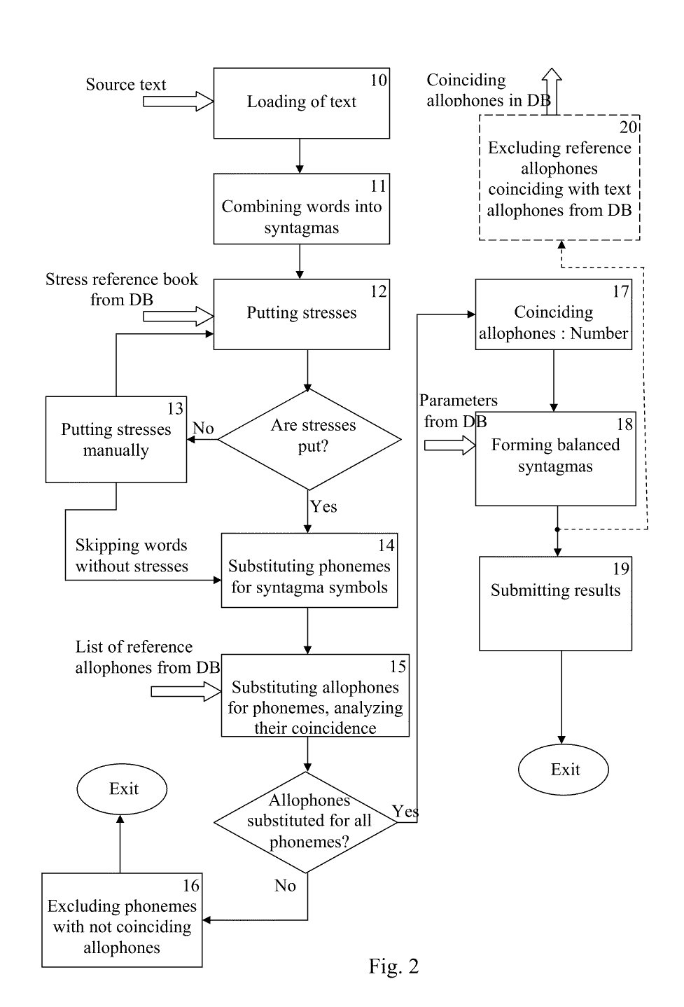

The computer device (FIG. 1) works in accordance with the following algorithm (FIG. 2).

The unit 10 loads a source text, reduces the source text to a normalized orphographic text by converting abbreviations into a linear text. Then, the unit 10 separates the text into sentences and words. The unit 11 performs an analysis of the linear text and combines the words into syntagmas. The syntagmas come to the unit 12 that marks phrase and word stresses. Stresses in syntagma symbols are put in accordance with a stress reference book takes from the database (DB) of the unit 3, where this book is inputted by the unit 5 (FIG. 1). The “Are stresses put?” deciding unit (FIG. 2) checks whether stresses have been put and, if necessary, sends, through its “No” output (where stresses are not put), a proposal on putting stresses to the unit 13 one output of which serves for skipping words without stress and is connected to the input of the unit 14 intended for substitution of phonemes for syntagma symbols. The other output of the unit 13 is connected to the second input of the unit 12, and stresses may be put manually. Data on syntagmas come from the “Yes” output of the “Are stresses put?” deciding unit to the unit 14 intended for substitution of phonemes for syntagma symbols (letters).

Then, the phonemes in the syntagmas come to the unit 15 intended for substitution of allophones for phonemes in accordance with a list of reference allophones coming from the DB of the unit 3 (FIG. 1) where they are inputted by the unit 5. The output of the unit 15 (FIG. 2) provides (ideal) syntagma transcriptions in terms of phonemes and allophones. The “Are Allophones substituted for all phonemes?” deciding unit sorts the syntagmas according to coinciding allophones. If the allophones of the source text syntagmas have no coincidences with reference allophones, then the deciding unit sends the corresponding data from its output “No” to the unit 16 for excluding phonemes with non-coinciding allophones. In a case where all allophones of the source text syntagmas have coincidences with reference allophones, then this deciding unit sends data on the coinciding allophones from its output to the input of the unit 17. The unit 17 forms a “coinciding allophones: their number” list. This list comes to the balanced syntagma forming unit 18 that also receives from the DB the following parameters: the source text, the minimum percent of syntagma balance or the number of syntagmas. The unit 18 performs a search for syntagmas having a greatest number of coinciding allophones, which come, respectively, to the result submission unit 19 and to the output of the unit 4 (FIG. 1). In order to reduce (“narrow”) the DB of reference allophones, the balanced syntagma forming unit 18 may also provide the list of allophones (as shown with a dashed line in FIG. 2) to the unit 20 for excluding reference allophones that coincide with the allophones of the text from the DB, in order to reduce the volume of the reference allophones database. This helps to additionally reduce information resources and accelerate the process of information processing. This list is transmitted to the DB, respectively.

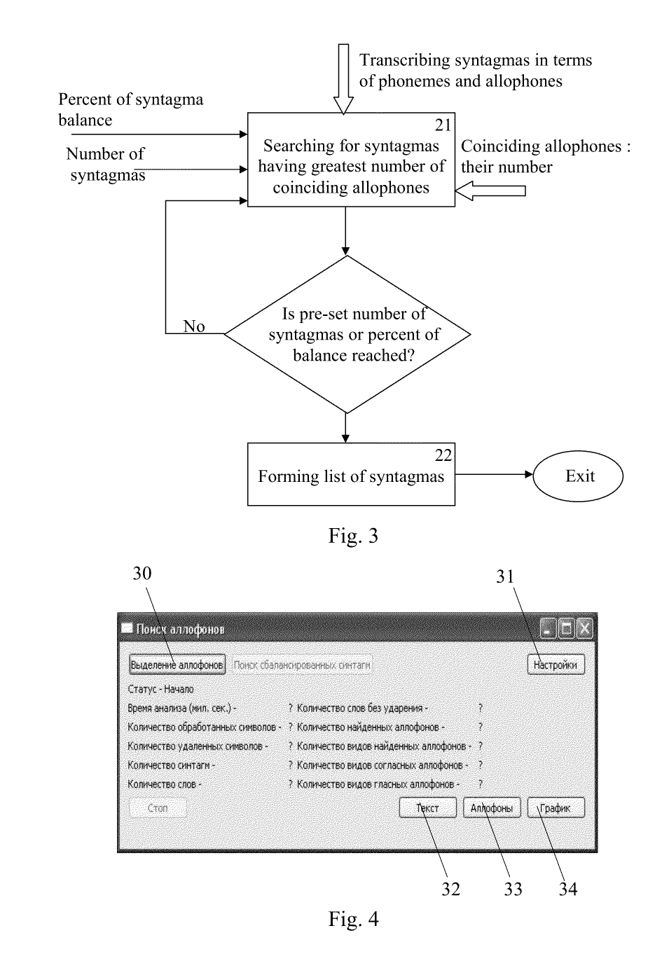

The balanced syntagma forming unit works in accordance with the following algorithm (FIG. 3).

Syntagma transcriptions in terms of phonemes and allophones according to coinciding allophones as well as a “coinciding allophones: their number” list come from the output of the “Are allophones substituted for all phonemes” deciding unit (FIG. 2) through the unit 17. The unit 21 (FIG. 3) receives, at its control inputs, this data as well as data on the pre-set parameters of a minimum percent of syntagma balance or a minimum number of balanced syntagmas. The unit 21 performs a search for syntagmas having a greatest number of coinciding allophones (in the source text and reference allophones). If the pre-set number of syntagmas or the percent of balance is not reached, then data to this extent is sent from the “No” output of the deciding unit to the third control input of the unit 21, and the unit 21 performs a search for the next syntagma over the coinciding allophones. If a pre-set number of syntagmas or a minimum percent of balance is reached, then the data to this extent is sent from the output of the deciding unit to the unit 22 that forms a list of balanced syntagmas.

Thus, balanced syntagmas may be formed as a table in the order of their balance, and/or a total number of balanced syntagmas may be pre-set, and/or a percent of balanced syntagmas in their total number may be pre-set.

Furthermore, in order to reduce a volume of reference allophone databases and accelerate the process of forming balanced syntagmas, it is possible to exclude, for the most balanced syntagma from the reference allophones database, those reference allophones that are already contained in this most balanced text syntagma in the unit 20 (FIG. 2). For the next, less balanced text syntagma the reference allophones, as contained therein, are excluded from the reference allophone database. The process of reducing the reference allophones database is repeated for next, less balanced syntagmas, in order to reach the pre-set number of balanced syntagmas or the pre-set percent of balanced syntagmas in the total number of syntagmas.

Then, after balanced syntagmas for another text fragment are identified, the claimed method may be repeated. Coincidences of syntagma transcription allophones are compared to reference allophones in the reduced database of reference allophones, and syntagma transcription phonemes and allophones are excluded that do not coincide with reference allophones. Balanced text syntagmas, i.e., those having a greatest number of coincidences of syntagma transcription allophones and reference allophones, are formed from syntagma transcription allophones coinciding with reference allophones.

The claimed method enables to teach systems most efficiently. Thereafter phrases corresponding to balanced syntagmas will be pronounced by a speaker whose voice specimen will be kept in the process of teaching systems. Efficient teaching is understood as teaching of a system with best quality (absence of artifacts, naturalness of speech, good intelligibility) with a least possible duration of the teaching process. As is shown by tests conducted, for example, for the technical solution disclosed in RU Patent No. 2393548, during the teaching period a speaker should read only 60 to 75 phrases corresponding to balanced syntagmas, instead of reading 100 phrases, which reduces, while keeping similar high quality of replaying, a pronounced text used for teaching a system by at least 25%.

The invention is illustrated by possible variants of graphic interfaces displayed on the monitor of a computer device.

The user starts special software on the computer device for text processing (FIG. 1). The graphic interface (FIG. 4) is displayed as a dialog box having tools (buttons) 30, 31, 32, 33, 34. The tool 30 “Extraction of Allophones” serves for loading a source text from a text file stored on a disc, the tool 31 “Settings” serves for editing a stress reference book and a list of reference allophones, the tool 32 “Text” serves for displaying the area where results of extracting syntagmas, phonemes and allophones are submitted, the tool 33 “Allophones” serves for displaying the area where a table “Phonemes—Allophones—Number found in the text” is presented, the tool 34 “Plot” serves for visual graphic analysis of text balance.

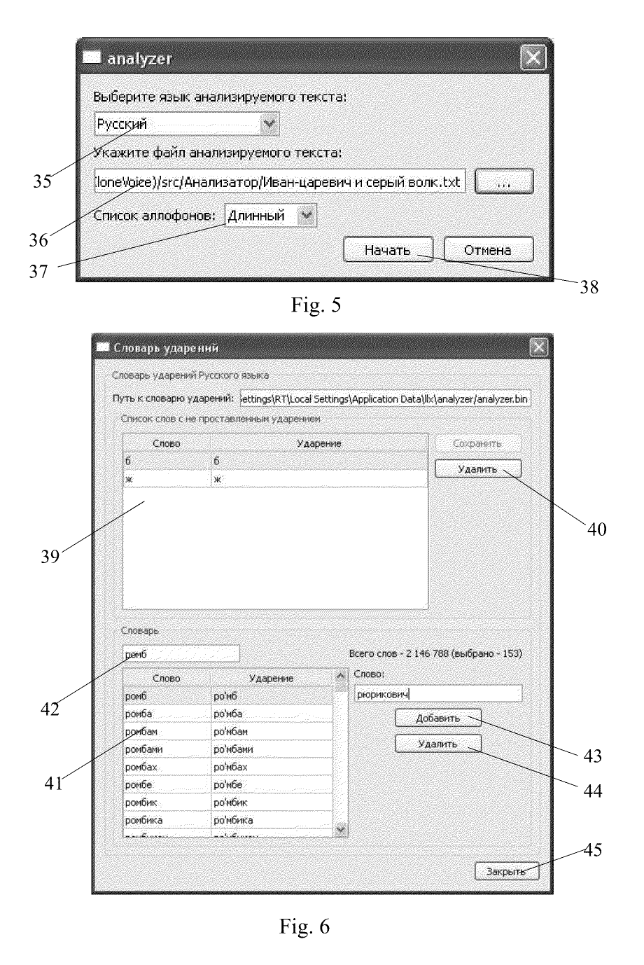

In order to load a text from a file, the user presses the button “Extraction of Allophones”. In the box displayed (FIG. 5) the user indicates: a language of the text to be analyzed in the drop-down list “Choose Language” with the tool 35, the full path to the file containing the source text in the data field “Indicate File” with the tool 36. The data field of allophone list of the tool 37 serves for selection of a mini-set of reference allophones and a maxi-set of reference allophones. The tool 38 “Start” serves for application of settings selected.

The text analysis unit 2 (FIG. 1) separates the source text, as selected by the user at the previous step, into syntagmas. Stresses are put in words contained in each extracted syntagma. Stresses are put with the use of the stress reference book contained in the database unit 3. Also, the stress reference book may be edited by the user. In order to edit the stress reference book, the user presses the tool 31 “Settings” (transition□“Stress Reference Book” in the graphic interface displayed (FIG. 4). In the graphic interface displayed (FIG. 6) the user can edit the stress reference book. The data field 39 is used for preparing a list of words having no stresses put. The tool 40 “Delete” is intended for deletion of a word from the data field 39 for the purpose of subsequently putting stress manually. The data field 41 serves for putting stresses manually and for preparing a list of words for a word inputted in to the data field 42. The tools 43, 44 are used for adding a word or deleting it, respectively. The tool 45 “Close” is intended for inputting a reference book of stresses out manually into the database unit 3 with the use of the unit 5 (FIG. 1).

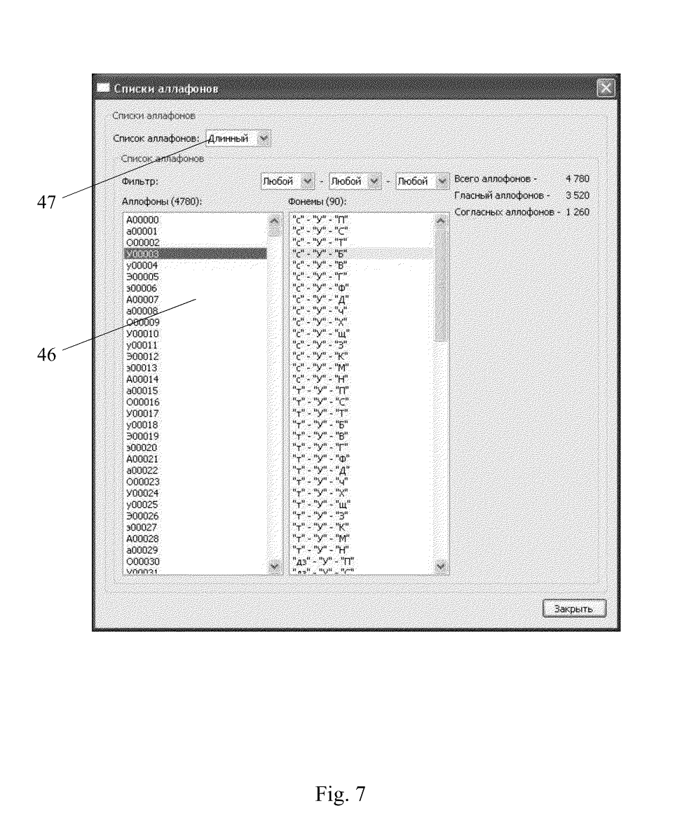

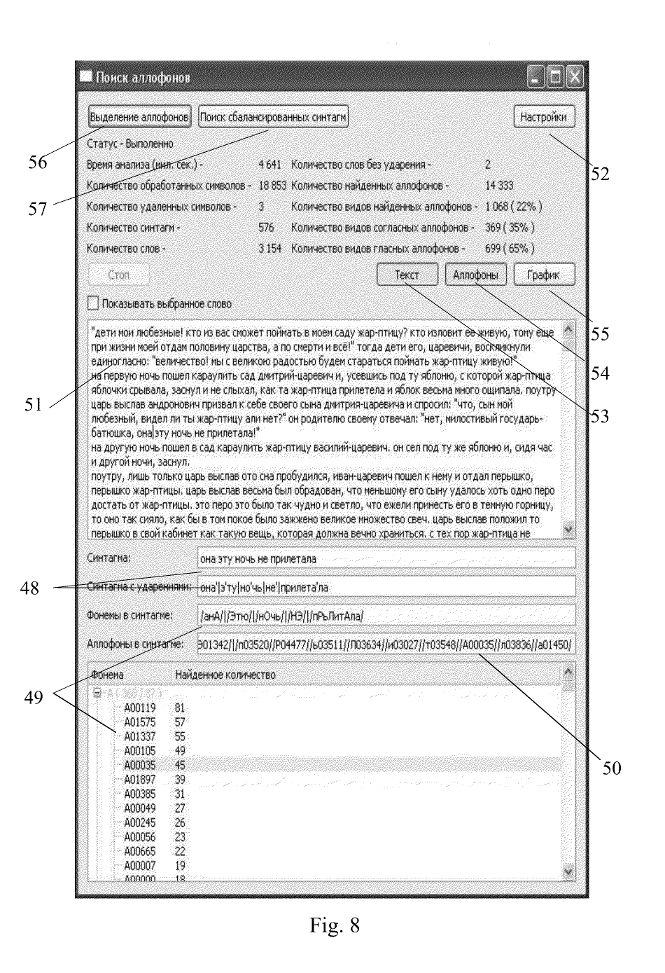

The text analysis unit 2 substitutes phonemes for syntagma symbols (letters) and allophones for phonemes. The substitution of allophones for the source text phonemes is performed according to a list of reference allophones that is contained in the database unit 3. The allophone list may be also edited by the user. In order to edit a list of reference allophones, the user presses the tool 31 “Settings” (transition)—“Lists of Allophones” in the graphic interface (FIG. 4). In the graphic interface displayed (FIG. 7), the user can edit a list of allophones in the data field 46 after selecting a mini-set of reference allophones or a maxi-set of reference allophones in the data field 47. The user may see the result of extracting allophones from a text analyzed by pressing the tools 32, 33 “Text” and “Allophones” (FIG. 4). The result of extracting syntagmas, phonemes, allophones is shown in the graphic interface (FIG. 8) in the data fields 48, 49, 50, respectively. The source text is shown in the data field 51. The tool 52 “Settings” serves for editing a stress reference book and the list of reference allophones, the tool 53 “Text” is used for the text, the tool 54 “Allophones” serves for displaying the area presenting the results of extracting syntagmas, phonemes and allophones from a text, the tool 55 “Plot” is used for visual graphic analysis of text balance, the tool 56 “Extraction of Allophones” is used for loading a source file from a text file stored on a disc.

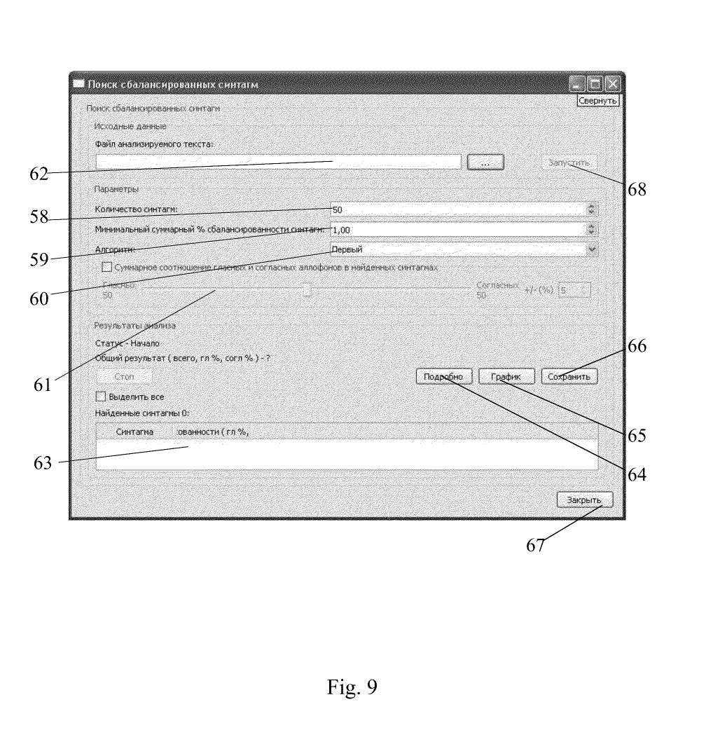

In order to search for balanced syntagmas, the user presses the tool (button) 57 “Search For Balanced Syntagmas” in the graphic interface displayed (FIG. 8). The graphic interface, as presented in FIG. 9, will be displayed.

The user indicates the following parameters for a text analysis in this graphic interface (FIG. 9):

Data field 58—Number of syntagmas (having best phonetic balance);

Data field 59—Minimum total percent of balance of syntagmas;

Data field 60—Algorithm for text analysis (the first or the second one, the algorithms are described in more detail below);

Data field 61—Total relation of vowel and consonant allophones in syntagmas found;

Data field 62—Field for inputting the path to and the name of the file containing the source text;

Data field 63—Table of “Syntagma” kind—“% of balance (% of vowels, % of consonants)”.

The tool 64 “In detail” is used for displaying the box “About syntagma in detail” comprising: the field “Syntagma”, the field “Syntagma with stresses”, the field “Phonemes in syntagma”, the field “Allophones in syntagma”, the list “Coincided allophones”, the list “Not coincided allophones”.

The tool 65 “Plot” is used for presented analysis results in graphic form, the tool 66 “Save” is used for saving the analysis result (table of balanced syntagmas of the “Syntagma” kind—“% of balance % of vowels, % of consonants)”) in a text file on a disc, the tool 67 “Close” is used for closing the box “Search for balanced syntagmas”.

The user presses the tool 68 “Start” in the graphic interface displayed (FIG. 9).

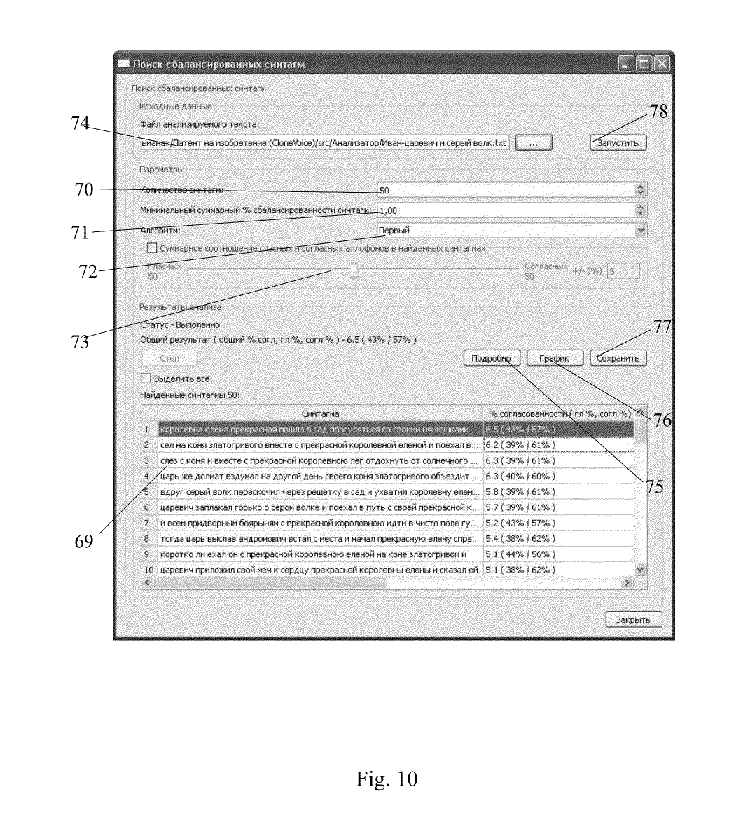

This set of balanced syntagmas is displayed to the user on the monitor screen of a computer device (FIG. 10) in the data field 69. The functions of the data fields 0÷74 and the tools 75÷78 correspond to the data fields and the tools shown in FIG. 9.

The text analysis unit 2 (FIG. 1) determines a number of allophones found in the source text that coincide with reference allophones, their uniqueness and frequency of appearance in the text. The result of this analysis is a list, as prepared and stored in the database unit 3, of the kind: “coincided allophones”—“their number in the text”. The unit 6 for search for balanced syntagmas performs an analysis of the text and extraction of syntagmas that are most balanced and phonetically characterize the source text in the best way therefrom.

The analysis of a text may be performed according to various methods. Two possible algorithms for text analysis are described below.

The first algorithm: extraction of syntagmas with the best phonetic balance (i.e., those comprising a greatest number of coinciding allophones) in the order of their balance from the text. A number of these syntagmas is limited by the user's setting (number of syntagmas) or by the system, depending on a percent of syntagma balance, as pre-set by the user (a minimum total percent of syntagma balance). The first algorithm enables to obtain the best quality of reading the source text by a speaker, but requires more time for data processing.

The second algorithm: an analysis of a number of allophones found in a text coinciding with reference allophones contained in the base of reference allophones in the system (i.e., relation of a number of allophones in a text to a number of reference allophones in the system base). The allophones in the system base, as are not found in a text, are not taken into account in a subsequent analysis (a base of considered allophones becomes “narrower”). The most balanced syntagma of the text is determined (that comprising a greatest percent of reference allophones from the base). Allophones contained in the most balanced syntagma identified are excluded from the base of reference allophones. Then, the next, less balanced syntagma is determined, and “narrowing” of the base of reference allophones is performed similarly. The “narrowing” process for the base of reference allophones is repeated until a pre-set number of syntagmas or a minimum total percent of syntagma balance is reached. The second algorithm enables to shorten time required for processing of mathematically formalized text data.

It is evident that other algorithms will be apparent to those skilled in the art.

### INDUSTRIAL APPLICABILITY

The claimed method for automated text processing and computer device for implementing the method may be most successfully applied for teaching systems of speech recognition and synthesis.

1. A method for preliminary text processing by a text processor, comprising the steps of:
reducing a source text to a normalized orphographic text by converting abbreviations into a linear text;
segmenting the orphographic text into sentences and words;
marking of phrase and word stresses;
combining words into syntagmas with putting pause symbols at syntagma ends; and
transcribing the syntagmas for obtaining syntagma transcriptions in terms of phonemes and allophones,
wherein a database of reference allophones is additionally formed in the text processor, wherein coincidences between syntagma transcription allophones and reference allophones are compared, wherein syntagma transcription allophones that do not coincide with reference allophones are excluded, and wherein syntagma transcription allophones coinciding with reference allophones form balanced text syntagmas having a greatest numbers of coincidences between syntagma transcription allophones and reference allophones.

2. A method according to claim 1, wherein balanced syntagmas are formed as a table in order of balance.

3. A method according to claim 2, wherein a number of balanced syntagmas is pre-set.

4. A method according to claim 2, wherein a percent of balanced syntagma number in the total number of syntagmas is pre-set.

5. A method according to claim 2, of further comprising the steps of:
reducing a reference allophone database, wherein reference allophones contained in the most balanced text syntagma are excluded from that most balanced text syntagma, then reference allophones contained in the next, less balanced text syntagma are excluded therefrom; and
repeating the step of reducing the reference allophone database for subsequent less balanced syntagmas for achieving a pre-set number of balanced syntagmas, having a pre-set percent of balanced syntagmas in a total number of syntagmas.

6. A computer device for text processing, comprising:
a text input unit,
an analysis unit,
a database unit, and
a result submission unit,
a parameter input unit, and
a balanced syntagma forming unit,
wherein a first output of the text input unit is connected to a first input of the analysis unit,
wherein an output of the database unit is connected to a second input of the analysis unit,
wherein an output of the parameter input unit is connected to a database unit input so as to form a reference allophone database,
wherein an output of the analysis unit is connected to a second input of the database unit,
wherein an output of the database unit is connected to an input of the balanced syntagma forming unit, said balanced syntagmas having a greatest number of coincidences between text allophones and reference allophones, and
wherein an output of the balanced syntagma forming unit is connected to an input of the result submission unit.
